(19) United States
(12) Patent Application Publication
(10) Pub. No.: US 2019/0272354 A1
(43) Pub. Date: Sep. 5, 2019

(54) Method for degradation modeling and lifetime prediction considering recoverable shock damages

(71) Applicant: Beihang University, Beijing (CN)

(72) Inventors: Tingting Huang, Beijing (CN); Yuepu Zhao, Beijing (CN); Shunkun Yang, Beijing (CN); Zixuan Yu, Beijing (CN); Xin Wu, Beijing (CN); Shanggang Wang, Beijing (CN)

(73) Assignee: Beihang University

(21) Appl. No.: 16/419,871

(22) Filed: May 22, 2019

(30) Foreign Application Priority Data
Mar. 6, 2019 (CN) 201910166314.1

(51) Int. Cl. G06F 17/50

(52) U.S. Cl. CPC G06F 17/5009

(57) ABSTRACT

A method for degradation modeling and lifetime prediction considering recoverable shock damages includes steps of: Step 1: collecting degradation data; Step 2: establishing a degradation model; Step 3: estimating the parameters; and Step 4: predicting lifetime and reliability. Advantages and effects of the present invention are: A) The method of the present invention takes into account the conditions under which the shock damage can be partially or fully recovered, improving the prediction accuracy of lifetime and reliability of products meeting such conditions. B) The method of the present invention considers the shock effects on product performance, which considers the shock effects on both the degradation rate and the degradation signal, wherein prediction method is more realistic and prediction accuracy is improved. C) Many conventional degradation models are special cases when some of the parameters to be estimated in the model of the present invention are zero.

### CROSS REFERENCE OF RELATED APPLICATION

The present invention claims priority under 35 U.S.C. 119(a-d) to CN 201910166314.1, filed Mar. 6, 2019.

### BACKGROUND OF THE PRESENT INVENTION

### Field of Invention

The present invention relates to a method for degradation modeling and lifetime prediction considering recoverable shock damages, belonging to a technical field of degradation modeling and lifetime prediction.

### Description of Related Arts

With the development of technology, the reliability of products is getting higher and higher. For the characteristics of long lifetime and high reliability of products, degradation modeling based on degradation data is usually used to predict the lifetime of products. The conventional degradation modeling method only considers that the damages to the product degradation signal cannot recover. However, during the actual use of the product, the damages caused by the shocks on the degradation signal of some products may be partially or fully recover over time. Therefore, there may be errors in the lifetime prediction of the product by the conventional methods, which may result in inaccuracy in major decisions such as product replacement and condition-based maintenance based on the predicted product lifetime. In order to improve the prediction accuracy, a method for degradation modeling and lifetime prediction considering recoverable shock damages is provided.

Degradation modeling is based on physical quantities that are closely related to products lifetime and reliability, that is, performance, wherein quantitative mathematical models are used to describe their laws over time. The present invention takes into account the shock effects on both product degradation signals and degradation rate in degradation modeling. The effects of shock on degradation signals may be partially or fully recover over time. According to the above description, the effect of shock on product performance is introduced into the degradation model, so as to establish a product performance degradation model considering recoverable shock damages, and provide a residual lifetime prediction method. For products whose degradation signal can be recovered after shock damage, considering condition changes during product use is more in line with the actual situation, and can also effectively improve the prediction accuracy of product residual lifetime.

Conventionally, a lot of research has been done in the field of product performance degradation modeling all over the world. Fruitful scientific research results have been obtained, and engineering applications in various fields have been instructed. The conventional method of degradation modeling mainly consider that the shock damages on product degradation signal is unrecoverable. In recent years, as product reliability requirements have become higher and higher, degradation modeling considering recoverable shock damages, which is closer to the actual use of the product, has become a hot spot. A summary of global research status in the field of degradation modeling is described as follows.

As the product becomes more complex and systematic, the conventional reliability model based on product failure time has been difficult to meet the requirements of modern industrial development. Therefore, degradation modeling and lifetime prediction techniques based on product degradation data are proposed and developed. Modeling based on product degradation data mainly includes three kinds of methods: degradation path, time-varying parameters distribution, and stochastic processes. Lu C J. and Meeker W Q. [Lu C J, Meeker W Q. Using degradation measures to estimate a time-to-failure distribution [J]. Technometrics, 1993, 35(2): 161-174.] proposed a nonlinear relationship model involving sample degradation path with time, so as to find a more general statistical method and data analysis method to evaluate the product time-to-failure distribution. The model considers the degradation measurement of the product at any time as a corresponding measurement error part and an actual degradation path part with unknown parameters. The actual degradation path also contains fixed effects common to all samples and random effects describing the individual characteristics of each sample. Zuo M J et al. [Zuo M J, Jiang R, Yam R C M. Approaches for reliability modeling of continuous-state devices [J]. IEEE transactions on reliability, 1999, 48(1): 9-18.] adopted Weibull distribution to represent the distribution of the degradation of product performances, so as to construct the degradation model and predict the product lifetime. Whitmore G A. [Whitmore G A. Estimating degradation by a Wiener diffusion process subject to measurement error [J]. Lifetime data analysis, 1995, 1(3): 307-319.] used a Wiener process to model the degradation trend of the products, so as to describe the differences of the inherent characteristics of the products over time during the degradation process. Because the Wiener process model has good computational analysis characteristics and can describe the degradation process of many typical products, it has become one of the most basic and widely used models in reliability degradation modeling.

During usage, besides degradation process, external shocks can also affect the degradation process of products. In the conventional shock models, the shock is usually defined as an instantaneous shock. According to the randomness or certainty of the shocks occurrence time, shocks can be divided into random shock and stress transition shock. The random shock occurrence time is usually described by a random process, Ross S M. [Ross S M. Generalized Poisson shock models [J]. The Annals of Probability, 1981, 9(5): 896-898.] discussed the general Poisson shock model in detail, namely the shock occurrence time follows the Poisson distribution. Conventionally, great progress has been made in the study of random shock models. Random shocks are mainly divided into four categories. 1) Extreme shock: Gut A. [Gut A. Extreme shock models [J]. Extremes, 1999, 2 (3): 295-307.] proposed that when the shock magnitude is greater than a critical threshold resulting in product failure, the shock is an extreme shock. 2) Cumulative shock: Gut A. [Gut A. Cumulative shock models [J]. Advances in Applied Probability, 1990, 22(2): 504-507.] proposed that when the cumulative damages of multiple shocks is greater than a critical threshold resulting in product failure, the shock is a cumulative shock. 3) Run Shock: Mallor F and Omey E. [Mallor F, Omey E. Shocks, runs and random sums [J]. Journal of Applied Probability, 2001, 38(2): 438-448.] proposed that when consecutive k shock magnitudes are greater than a critical threshold resulting in product failure, the shock is a run shock. 4) δ shock: Ma M and Li Z. [Ma M, Li Z. Life behavior of censored δ-shock model [J]. Indian Journal of Pure and Applied Mathematics, 2010, 41(2): 401-420.] proposed that when the time interval of two consecutive shocks is less than a critical threshold resulting in product failure, the shock is a δ shock.

In addition, in some studies, the researchers considered both the natural degradation process of the product and the shock effects on the product. Li W and Pham H. [Li W, Pham H. Reliability modeling of multi-state degraded systems with multi-competing failures and random shocks [J]. IEEE Transactions on Reliability, 2005, 54(2): 297-303.] provided a model that considers both the degradation process and the random shock effect, and the degradation process and the random shock effect are assumed to be independent. Song S et al. [Song S, Coit D W, Feng Q. Reliability for systems of degrading components with distinct component shock sets [J]. Reliability Engineering & System Safety, 2014, 132: 115-124.] adopted random shock to describe the random environment or load acting on the degradation process of product performance. At the same time, the random shock will cause the degradation signal to increase or decrease immediately. Wang Z et al. [Wang Z, Huang H Z, Li Y, et al. An approach to reliability assessment under degradation and shock process [J]. IEEE Transactions on Reliability, 2011, 60(4): 852-863.] proposed a degradation model that considers both the degradation process and the shock effect, wherein the model divides the shock effects on the product degradation process into two categories, one of which is shock damage to the degradation signals and the other type is the increase of degradation rate.

Most of the conventional shock damage models consider the damage to the product to be unrecoverable, but in practical engineering applications, many products or materials have a certain recovery effect on the damage of product degradation signals caused by shocks. Yahiro M et al. [Yahiro M, Zou D, Tsutsui T. Recoverable degradation phenomena of quantum efficiency in organic EL devices [J]. Synthetic Metals, 2000, 111: 245-247] proved that product performance of two-layer organic electroluminescent devices can be recovered after the shock. Nakagawa T. [Nakagawa T. On cumulative damage with annealing [J]. IEEE Transactions on Reliability, 1975, 24(1): 90-91.] and [Nakagawa T. Shock and damage models in Reliability theory [M]. Springer Science & Business Media, 2007.] proposed that in the usage of rubber, fiber reinforced plastic, polyurethane and other materials, the shock damage on the product can be recovered, and a degradation model was proposed. It can be seen that there are relatively few existing studies on degradation modeling considering recoverable shock damages.

### SUMMARY OF THE PRESENT INVENTION

In product degradation modeling and lifetime prediction, most models only consider shock damage on product degradation signal is unrecoverable, but in actual situations, the shock damage on many products can be partially or fully recovered over time. As a result, conventional methods cannot solve some practical engineering problems well. An object of the present invention is to provide a method for degradation modeling and lifetime prediction considering recoverable shock damages. Shock effects on product degradation signals and degradation rate are described, so as to establish a relationship between shock and product performance considering recoverable shock damages, to improve product lifetime prediction accuracy. Many conventional models can be considered as special cases of this model when certain parameters in the model of the present invention are zero.

The present invention provides a method for degradation modeling and lifetime prediction considering recoverable shock damages, and the method is also applicable to situation that the shock damage is unrecoverable after shock. The overall technical scheme of the method of the present invention is as shown in FIG. 1. First, degradation data are collected, then a degradation model is established, parameters in the model are estimated, and lifetime and reliability prediction is finally performed. The specific steps are as follows:

Step 1: collecting degradation data;

wherein the degradation data are collected through experiments or field use, under each stress profile, the degradation data and a corresponding stress state quantity are sampled once at each preset sampling time point, so as to collect data in real time;

Step 2: establishing a degradation model;

wherein the degradation model is expressed by an initial value, a cumulative degradation rate effect, a shock damage effect, and a Wiener process as shown below,

$$X ( t ) = X ( 0 ) + {{\int }^{t}}_{0} r ( w ( v ) ) dv + {\sum }_{j = 1}^{n ( t )} {Z}_{j} ( t ) + {σ}_{B} B ( t )$$

wherein X(0) is the initial value of the product;

B(t) is a standard Wiener process, B(t)˜N(0, t);

w(t) is a value of an environment or a load at time t;

r(t) is the degradation rate at time t;

σ_{B} is a diffusion parameter reflecting difference and instability during a product degradation process;

$${\sum }_{j = 1}^{n ( t )} {Z}_{j} ( t )$$

is a sum of shock damage caused by shocks up to time t, wherein j is the number of shock, N(t) is the number of the shocks occurred until time t, and Zⱼ(t) is an effect on a product degradation signal caused by the j^{th} shock until time t;

wherein l is further defined as a shock damage recovery critical threshold; when a shock magnitude is greater than l, a shock damage is not fully recoverable; otherwise, the shock damage is fully recoverable; the shock damage, which is an effect on the product degradation signal caused by the shocks, is expressed by an exponential function as follows,

if Δw(τⱼ)<l,

Zⱼ(t)=αΔw(τⱼ)·exp[−β(t−τⱼ)], t≥τⱼ

if Δw(τⱼ)≥l,

Zⱼ(t)=αΔw(τⱼ)·exp[−β(t−τⱼ)]+γΔw(τⱼ), t≥τⱼ

wherein α, β and γ are parameters to be estimated, τⱼ is an actual occurrence time of the j^{th} shock, and Δw(τⱼ) is the shock magnitude at the time τⱼ; γΔw(τⱼ) is a unrecoverable shock damage on the product degradation signal after a shock occurs;

as a special case, when α=0 and β=0,

if Δw(τⱼ)<l,

Zⱼ(t)=0, t≥τⱼ

if Δw(τⱼ)≥l,

Zⱼ(t)=γΔw(τⱼ), t≥τⱼ

for this case, Zⱼ(t) represents a product performance degradation process in which a shock damage is unrecoverable;

in addition, the degradation rate can be affected by the instantaneous shock, Dₑ is defined as a shock magnitude critical threshold which changes the degradation rate; when the shock magnitude is greater than Dₑ, the degradation rate increases, otherwise, the product performance degradation rate is unchanged; the shock effect on the product performance degradation rate is expressed by:

if Δw(τⱼ)<Dₑ,

Δrⱼ=0

if Δw(τⱼ)≥Dₑ,

Δrⱼ=η·Δw(τⱼ)

the degradation rate is an accumulation of a product initial degradation rate and degradation rate increments after each shock,

$$r ( t ) = {r}_{0} + {\sum }_{j = 1}^{n ( t )} Δ {r}_{j}$$

$$wherein , \\ {r}_{0} \sim N ( μ , {σ}_{r}^{2} )$$

wherein, η is a parameter to be estimated, r₀ is the product initial degradation rate not affected by the shocks, r₀˜N(μ, σᵣ²); Δrⱼ is an increment of the degradation rate caused by the j^{th} shock;

Step 3: estimating the parameters;

wherein the degradation model assumes that a damage recovery process and the degradation rate increase process are independent of each other after the instantaneous shock; firstly, an estimation method of the critical thresholds l and Dₑ is proposed and estimated, and then other parameters are estimated according to a maximum likelihood method;

estimation of the critical thresholds l and Dₑ is divided into two cases according to whether the shock damage on the product degradation signal is recoverable:

1) when the shock damage on the product degradation signal is recoverable, and the degradation signal has a recoverable trend after the shocks:

for the degradation data collected in the Step 1, n is defined as the number of the shocks occurred until time t, and a degradation rate between the j^{th} and j−1^{th} shocks is calculated and denoted as r_{1 (j-1,j)}; for each shock j, j=1, 2, . . . , n, a degradation rate between the first degradation data before the j^{th} shock and the first degradation data when a degradation signal starts to increase after the shock is calculated and denoted as r_{2 (j)};

if there is at least once r_{2 (j)}>r_{1 (j,j+1)}, and there is at least once r_{1 (j,j+1)}−r_{1 (j-1,j)}>0, j=1, 2 . . . . , n−1; then,

$$l = \frac{{l}_{upper limit} + {l}_{lower limit}}{2}$$

$${l}_{upper limit} = min \{ Δ w ( {τ}_{j} ) : {r}_{2 ( j )} > {r}_{1 ( j , j + 1 )} , j = 1 , 2 , … , n - 1 \}$$

$${l}_{lower limit} = max \{ Δ w ( {τ}_{j} ) : {r}_{2 ( j )} = {r}_{1 ( j , j + 1 )} , j = 1 , 2 , … , n - 1 \}$$

when l_{lower limit} has no feasible solution, then l_{lower limit};

$${D}_{e} = \frac{{D}_{e upper limit} + {D}_{e lower limit}}{2}$$

$${D}_{e upper limit} = min \{ Δ w ( {τ}_{j} ) : {r}_{1 ( j , j + 1 )} - {r}_{1 ( j - 1 , f )} > 0 , j = 1 , 2 , … , n - 1 \}$$

$${D}_{e lower limit} = max \{ Δ w ( {τ}_{j} ) : {r}_{1 ( j , j + 1 )} - {r}_{1 ( j - 1 , f )} = 0 , j = 1 , 2 , … , n - 1 \}$$

when D_{e lower limit} has no feasible solution, then D_{e lower limit}=D_{e upper limit};

if there is at least once r_{2 (j)}>r_{1 (j,j+1)}, and there is no r_{1 (j,j+1)}−r_{1 (j-1,j)}>0, j=1, 2, . . . , n−1; then,

$$l = \frac{{l}_{upper limit} + {l}_{lower limit}}{2}$$

$${l}_{upper limit} = min \{ Δ w ( {τ}_{j} ) : {r}_{2 ( j )} > {r}_{1 ( j , j + 1 )} , j = 1 , 2 , … , n - 1 \}$$

$${l}_{lower limit} = max \{ Δ w ( {τ}_{j} ) : {r}_{2 ( j )} = {r}_{1 ( j , j + 1 )} , j = 1 , 2 , … , n - 1 \}$$

when l_{lower limit} has no feasible solution, then l_{lower limit}=l_{upper limit};

meanwhile, Dₑ→+∞;

if there is no r_{2 (j)}>r_{1 (j,j+1)}, and there is at least once r_{1 (j,j+1)}−r_{1 (j-1,j)}>0, j=1, 2, . . . , n−1; then,

$${D}_{e} = \frac{{D}_{e upper limit} + {D}_{e lower limit}}{2}$$

$${D}_{e upper limit} = min \{ Δ w ( {τ}_{j} ) : {r}_{1 ( j , j + 1 )} - {r}_{1 ( j - 1 , f )} > 0 , j = 1 , 2 , … , n - 1 \}$$

$${D}_{e lower limit} = max \{ Δ w ( {τ}_{j} ) : {r}_{1 ( j , j + 1 )} - {r}_{1 ( j - 1 , f )} = 0 , j = 1 , 2 , … , n - 1 \}$$

when D_{e lower limit} has no feasible solution, then D_{e lower limit}=D_{e upper limit};

meanwhile, l→+∞;

if there is no r_{2 (j)}>r_{1 (j,j+1)}, and there is no r_{1 (j,j+1)}−r_{1 (j-1,j)}≥0, j=1, 2, . . . , n−1; then l→+∞, Dₑ→+∞;

2) when the shock damage on the product degradation signal is unrecoverable, and the degradation signal has no recoverable trend after the shocks:

for the degradation data collected, n is defined as the number of the shocks occurred until time t, and a degradation rate between the j^{th} and j−1^{th} shocks is calculated and denoted as r_{1 (j-1,j)}; for each shock j, j=1, 2, . . . , n, an increment X(τⱼ)−X(τⱼ−1) of a degradation signal between the j^{th} shock and the j−1^{th} shock is calculated and denoted as ΔX₍ⱼ₎;

if there is at least once ΔX₍ⱼ₎>0, j=1, 2, . . . , n, and there is at least once r_{1 (j,j+1)}−r_{1 (j-1,j)}>0, j=1, 2, . . . , n−1; then,

$$l = \frac{{l}_{upper limit} + {l}_{lower limit}}{2}$$

$${l}_{upper limit} = min \{ Δ w ( {τ}_{j} ) : Δ {X}_{( j )} > 0 , j = 1 , 2 , … , n \}$$

$${l}_{lower limit} = max \{ Δ w ( {τ}_{j} ) : Δ {X}_{( j )} = 0 , j = 1 , 2 , … , n \}$$

when l_{lower limit} has no feasible solution, then l_{lower limit}==l_{upper limit};

$${D}_{e} = \frac{{D}_{e upper limit} + {D}_{e lower limit}}{2}$$

$${D}_{e upper limit} = min \{ Δ w ( {τ}_{j} ) : {r}_{1 ( j , j + 1 )} - {r}_{1 ( j - 1 , f )} > 0 , j = 1 , 2 , … , n - 1 \}$$

$${D}_{e lower limit} = max \{ Δ w ( {τ}_{j} ) : {r}_{1 ( j , j + 1 )} - {r}_{1 ( j - 1 , f )} = 0 , j = 1 , 2 , … , n - 1 \}$$

when D_{e lower limit} has no feasible solution, then D_{e lower limit}=D_{e upper limit};

if there is at least once ΔX₍ⱼ₎>0, j=1, 2, . . . , n, and there is no r_{1 (j,j+1)}−r_{1 (j-1,j)}>0, j=1, 2, . . . , n−1; then,

$$l = \frac{{l}_{upper limit} + {l}_{lower limit}}{2}$$

$${l}_{upper limit} = min \{ Δ w ( {τ}_{j} ) \text{:} Δ {X}_{( j )} > 0 , j = 1 , 2 , … , n \}$$

$${l}_{lower limit} = max \{ Δ w ( {τ}_{j} ) \text{:} Δ {X}_{( j )} = 0 , j = 1 , 2 , … , n \}$$

when l_{lower limit} has no feasible solution, then l_{lower limit}=l_{upper limit};

meanwhile, Dₑ→+∞;

if there is no ΔX₍ⱼ₎>0, j=1, 2, . . . , n, and there is at least once r_{1 (j,j+1)}−r_{1 (j-1,j)}>0, j=1, 2, . . . , n−1; then,

$${D}_{e} = \frac{{D}_{{e}_{upper limit}} + {D}_{{e}_{lower limit}}}{2}$$

$${D}_{e upper limit } = min \{ Δ w ( {τ}_{j} ) \text{:} {r}_{1 ( j , j + 1 )} - {r}_{1 ( j - 1 , j )} > 0 , j = 1 , 2 , … , n - 1 \}$$

$${D}_{e lower limit } = max \{ Δ w ( {τ}_{j} ) \text{:} {r}_{1 ( j , j + 1 )} - {r}_{1 ( j - 1 , j )} = 0 , j = 1 , 2 , … , n - 1 \}$$

when D_{e lower limit} has no feasible solution, then D_{e lower limit}=D_{e upper limit};

meanwhile, l→+∞;

if there is no ΔX₍ⱼ₎>0, j=1, 2, . . . , n, and there is no r_{1 (j,j+1)}−r_{1 (j-1,j)}>0, j=1, 2, . . . , n−1; then l→+∞, Dₑ→+∞;

other parameters α, β, γ, η, σ_{B} and σᵣ except the critical thresholds l and Dₑ are estimated according to the maximum likelihood method; specifically, according to the maximum likelihood principle and the Wiener process with independent increments, a maximum likelihood formula is obtained:

$$L ( α , β , γ , η , μ , {σ}_{B} , {σ}_{r} ) = {\prod }_{j = 0}^{n} {\prod }_{i = 1}^{{m}_{j}} \frac{1}{\sqrt{2 π ( {σ}_{B}^{2} Δ {t}_{i} + {σ}_{r}^{2} Δ {t}_{i}^{2} )}} \cdot exp [ - \frac{( {( Δ X ( {t}_{i} ) - ( μ + {\sum }_{p = 1}^{j} ( {I}_{j} \cdot ηΔ w ( {τ}_{j} ) ) ) Δ {t}_{i} - {\sum }_{q = 1}^{j} ( {Z}_{j} ( {t}_{i} ) - {Z}_{j} ( {t}_{i - 1} ) ) )}^{2} )}{( 2 ( {σ}_{B}^{2} Δ {t}_{i} + {σ}_{r}^{2} Δ {t}_{i}^{2} )} ] \\ wherein \\ {I}_{j} = \{ \begin{matrix}0 , & when Δ w ( {τ}_{j} ) < {D}_{e} \\ 1 , & when Δ w ( {τ}_{j} ) \geq {D}_{e}\end{matrix}$$

mⱼ is a cumulative number of the degradation data collected between the j−1^{th} shock and the j^{th} shock; wherein “between the j−1^{th} shock and the j^{th} shock” indicates that the degradation data collected at “the j−1^{th} shock” is not included, and the degradation data at “the j^{th} shock” is included; Δtᵢ is the time interval between an i−1^{th} degradation data and an i^{th} degradation data;

Step 4: predicting lifetime and reliability;

wherein a lifetime and reliability prediction model considering recoverable shock damages is established and a reliability curve is drawn, which specifically comprises steps of:

supposing D is a soft failure threshold, and T is a time when a degradation signal first exceeds the threshold D and causes soft failure,

T=inf{t≥0;X(t)≥D}

wherein a reliability function at the time t is expressed as:

R(t)=P{T>t}=P{max X(u)<D,0≤u≤t}

the degradation signal X(t) is divided into a deterministic part ζ(t) and a random part ψ(t), which are:

$$X ( t ) = ζ ( t ) + ψ ( t )$$

$$ζ ( t ) = X ( 0 ) + {\int }_{0}^{ t} ( μ + {\sum }_{j = 1}^{n ( t )} Δ {r}_{j} ) dv + {\sum }_{j = 1}^{n ( t )} {Z}_{j} ( t )$$

$$ψ ( t ) = X ( t ) - ζ ( t ) , ψ ( t ) \text{∼} N ( 0 , {σ}_{B}^{2} t + {σ}_{r}^{2} {t}^{2} )$$

as a result, the reliability function is then expressed as:

$$R ( t ) = P \{ max X ( u ) < D , 0 \leq u \leq t \} = P \{ ψ ( u ) < D - ζ ( u ) , 0 \leq u \leq t \} = P \{ ψ ( u ) < g ( u ) , 0 \leq u \leq t \}$$

$$g ( t ) = D - ζ ( t ) = D - X ( 0 ) - {\int }_{0}^{ t} ( μ + {\sum }_{j = 1}^{n ( t )} Δ {r}_{j} ) dv - {\sum }_{j = 1}^{n ( t )} {Z}_{j} ( t )$$

wherein g(t) is a curve boundary corresponding to a standard Wiener process;

for the curve boundary g(t), it is generally difficult to calculate an exact solution, even if it can be solved, it requires a lot of calculations; [Daniels H E. Approximating the First Crossing-Time Density for a Curved Boundary [J]. Bernoulli, 1996, 2(2):133-143.]proposed calculating an approximate solution of the curve boundary by a boundary tangent method, and linearizing g(t),

$$\tilde{g} ( t ) = {a}_{t} + {b}_{t} t$$

$${b}_{t} = \frac{d}{dt} g ( t ) = - ( μ + {\sum }_{j = 1}^{n ( t )} Δ {r}_{j} ) - {\sum }_{j = 1}^{n ( t )} {Z}_{j}^{′} ( t )$$

$${a}_{t} = g ( t ) - {b}_{t} t = g ( t ) + ( μ + {\sum }_{j = 1}^{n ( t )} Δ {r}_{j} ) t + ( {\sum }_{j = 1}^{n ( t )} {Z}_{j}^{′} ( t ) ) t$$

$${Z}_{j}^{′} ( t ) = - β \cdot αΔ w ( {τ}_{j} ) \cdot exp [ - β ( t - {τ}_{j} ) ] , t \geq {τ}_{j}$$

wherein αₜ and bₜ represent an intercept and a slope of \tilde{g}(t) at time t;

expressing the reliability function after linearizing g(t) as:

$$R ( t ) = P \{ max X ( u ) < D , 0 \leq u \leq t \} = P \{ ψ ( u ) < g ( u ) , 0 \leq u \leq t \} \approx P \{ ψ ( u ) < \tilde{g} ( u ) , 0 \leq u \leq t \}$$

according to the boundary tangent method of Daniels, obtaining an expression of a probability density distribution function ƒ(t) when first exceeding:

$$f ( t ) \approx \frac{1}{\sqrt{2 π t}} ( \frac{\begin{matrix}D - X ( 0 ) - {\int }_{0}^{ t} ( μ + {\sum }_{j = 1}^{n ( t )} Δ {r}_{j} ) dv - {\sum }_{j = 1}^{n ( t )} {Z}_{j} ( t ) + \\ ( μ + {\sum }_{j = 1}^{n ( t )} Δ {r}_{j} ) t + ( {\sum }_{j = 1}^{n ( t )} {Z}_{j}^{′} ( t ) ) t\end{matrix}}{t \sqrt{{σ}_{B}^{2} + {σ}_{r}^{2} t}} ) \cdot exp ( - \frac{{( D - X ( 0 ) - {\int }_{0}^{ t} ( μ + {\sum }_{j = 1}^{n ( t )} Δ {r}_{j} ) dv - {\sum }_{j = 1}^{n ( t )} {Z}_{j} ( t ) )}^{2}}{2 t ( {σ}_{B}^{2} + {σ}_{r}^{2} t )} )$$

then, expressing the reliability function as:

R(t)=1−∫₀^{t}ƒ(ν)dν; and

finally, drawing a curve based on the reliability model to predict the lifetime of the product.

Advantages and effects of the present invention are:

A) The method of the present invention takes into account the conditions under which the shock damage can be partially or fully recovered, improving the prediction accuracy of lifetime and reliability of products satisfying such conditions.

B) The method of the present invention considers the shock effects on product performance, which considers the shock effects on both the degradation rate and the degradation signal, wherein prediction method is more realistic and prediction accuracy is improved.

C) Many conventional degradation models are special cases when some of the parameters to be estimated in the model of the present invention are zero; the present invention can characterize different conventional degradation models by substituting values of different parameters to be estimated.

### BRIEF DESCRIPTION OF THE DRAWINGS

FIG. 1 is a flow chart of a method of the present invention;

FIGS. 2-6 are simulation diagrams of corresponding stress profile of the present invention;

FIGS. 7-11 are simulation diagrams of corresponding product degradation signals of the present invention;

FIGS. 12-16 are corresponding product lifetime prediction reliability curves and Kaplan-Meier (K-M) curves of the present invention.

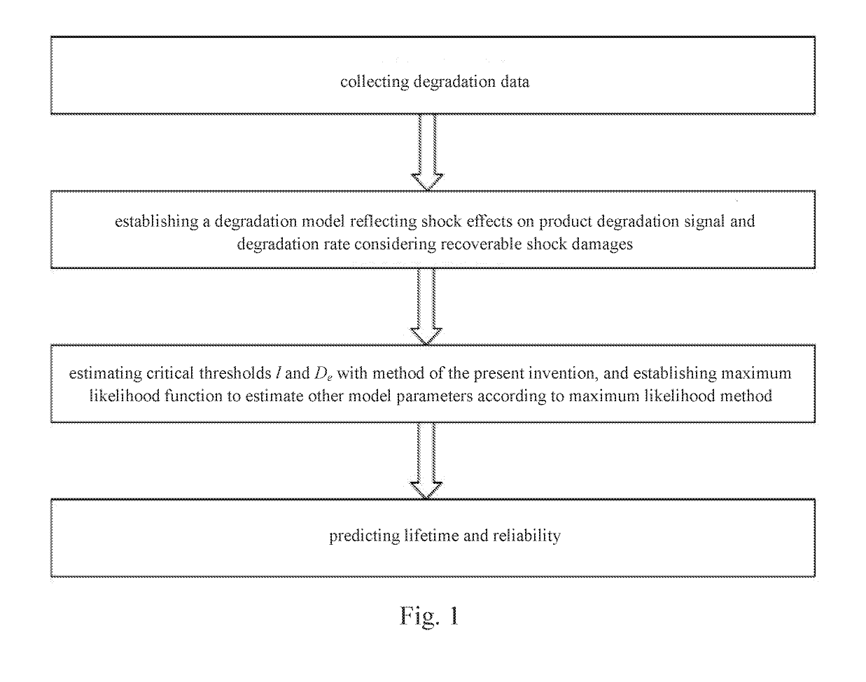

### DETAILED DESCRIPTION OF THE PREFERRED EMBODIMENT

For some high-reliability products, the stresses experienced by a product during use are often not constant, or simply monotonically increasing, or monotonically decreasing. A product is often affected by shocks due to sudden increases in load or sudden changes in the environment. For example, micro-electro-mechanical systems (MEMS) in the aerospace or automotive industries can be exposed to sudden change of loads or environmental stresses due to the different conditions of spacecraft or automobiles. Electronic products and their components under special conditions may also experience relatively complex electrical stresses, such as violent voltage fluctuations. In practical use, products are affected by both shocks and natural degradation, and they are all important factors that cause product failure. However, the shock effect on product degradation signal may partially or fully recover over time. For example, laser is a high-reliability, long-life product that may be subjected to shocks of unstable currents during use. The shocks may cause damage to the laser performance, but the damage may gradually recover over time. The present invention takes simulation as an example, wherein model parameters are pre-set according to different situations and simulation results are obtained. The pre-set parameters are estimated and the accuracy of the model prediction accuracy is verified by the method of the present invention.

Specifically, embodiments of the present invention respectively perform simulation verification for the following five cases: (1) critical threshold l is greater than Dₑ; (2) critical threshold l is less than Dₑ; (3) shock only affects product degradation signal and does not affect product degradation rate, wherein product degradation signal may be partially or fully recovered in a non-instantaneous form; (4) shock only affects product degradation rate and does not affect product degradation signal, wherein product degradation signal can be fully recovered in an instantaneous form; and (5) shock affects neither product degradation signal nor degradation rate.

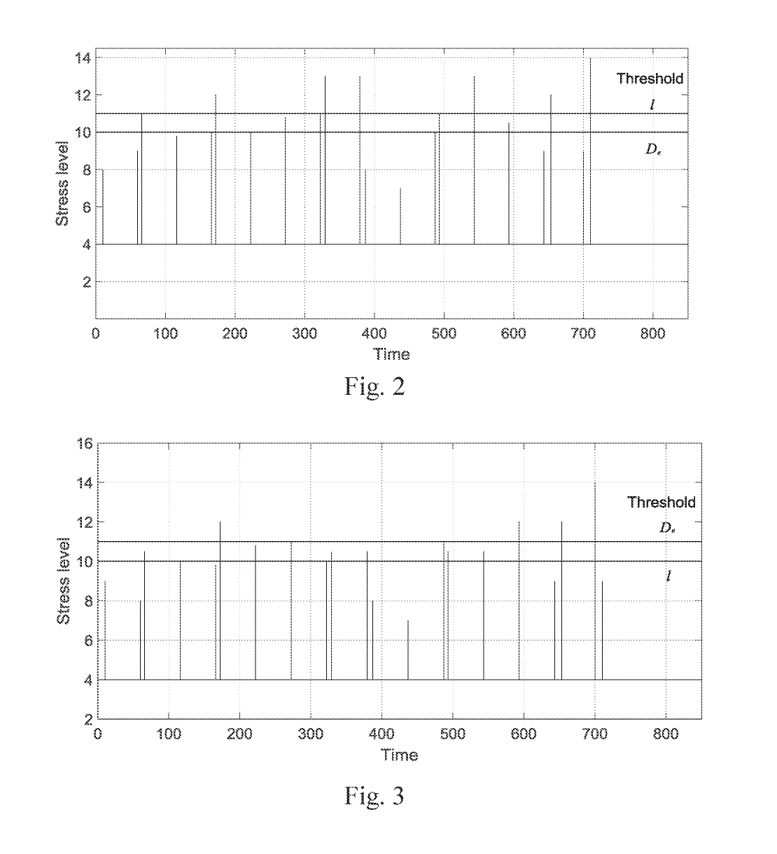

For the case that critical threshold l is greater than Dₑ, it is assumed that there are 100 products undergoing a 900-hour degradation test, and degradation data are generated every 0.01 hours. A stress profile is shown in FIG. 2. In a simulation process, the degradation data of the first 43700 data points are used to estimate model parameters, and then reliability is predicted. Corresponding failure data are obtained through the degradation data of the 43701st to 90000th data points, and prediction accuracy is verified. Selection of data points for parameter estimation and verification is determined according to experience. Generally, it should satisfy: (1) the amount of data selected during parameter estimation should be sufficient; (2) the data points selected during parameter estimation should be before the product failure times; (3) the data points selected during parameter estimation should contain data of corresponding situations to be analyzed. The remaining data is the corresponding failure data, which is used as the verification data. The degradation process of the product can be expressed as:

$$X ( t ) = X ( 0 ) + {\int }_{0}^{ t} r ( w ( v ) ) dv + {\sum }_{j = 1}^{n ( t )} {Z}_{j} ( t ) + {σ}_{B} B ( t )$$

wherein an initial value X(0)=0, and parameter setting values are as shown in Table 1:

TABLE 1

| D | Dₑ | l | α | β | γ | η | μ | σᵣ | σ_{B} |
|---|---|---|---|---|---|---|---|---|---|
| 500 | 6 | 7 | 1.8 | 0.3 | 0.2 | 0.01 | 0.5 | 0.3 | 0.9 |

For the case that critical threshold l is less than Dₑ, it is assumed that there are 100 products undergoing a 850-hour degradation test, and degradation data are generated every 0.01 hours. A stress profile is shown in FIG. 3. In a simulation process, the degradation data of the first 44000 data points are used to estimate model parameters, and then reliability is predicted. Corresponding failure data are obtained through the degradation data of the 44001st to 85000th data points, and prediction accuracy is verified. The performance degradation process of the product can be expressed as:

$$X ( t ) = X ( 0 ) + {\int }_{0}^{ t} r ( w ( v ) ) dv + {\sum }_{j = 1}^{n ( t )} {Z}_{j} ( t ) + {σ}_{B} B ( t )$$

wherein an initial value X(0)=0, and parameter setting values are as shown in Table 2:

TABLE 2

| D | Dₑ | l | α | β | γ | η | μ | σᵣ | σ_{B} |
|---|---|---|---|---|---|---|---|---|---|
| 500 | 7 | 6 | 1.8 | 0.3 | 0.2 | 0.015 | 0,5 | 0.3 | 0.9 |

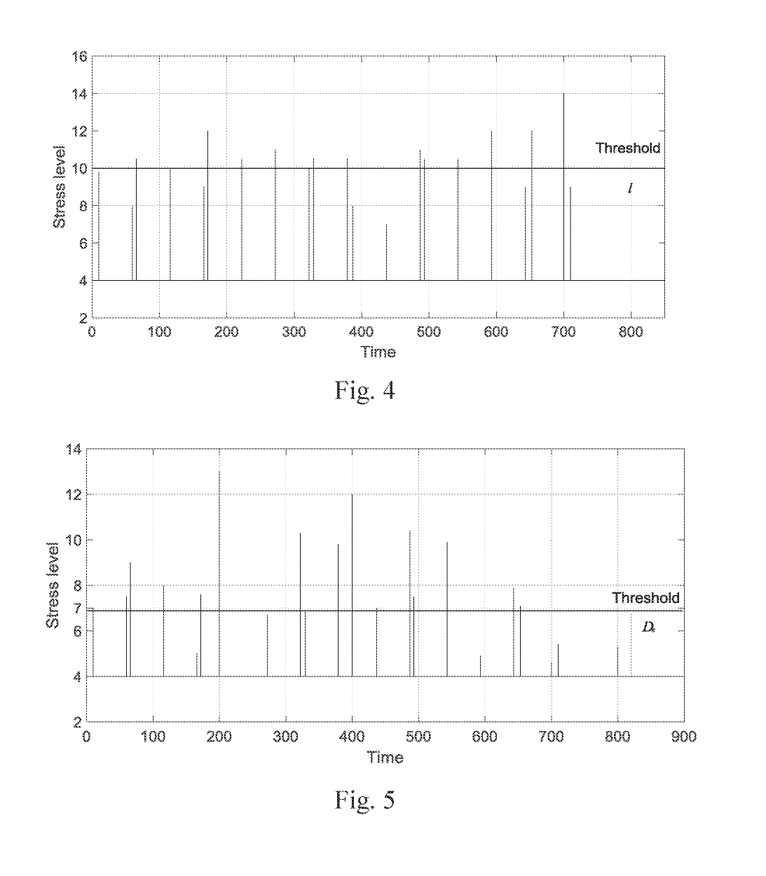

For the case that shock only affects product degradation signal and does not affect degradation rate, wherein product degradation signal may be partially or fully recovered in a non-instantaneous form, it is assumed that there are 100 products undergoing a 850-hour degradation test, and degradation data are generated every 0.01 hours. A stress profile is shown in FIG. 4. In a simulation process, the degradation data of the first 50000 data points are used to estimate model parameters, and then reliability is predicted. Corresponding failure data are obtained through the degradation data of the 50001st to 85000th data points, and prediction accuracy is verified. The performance degradation process of the product can be expressed as:

$$X ( t ) = X ( 0 ) + {\int }_{0}^{ t} r ( w ( v ) ) dv + {\sum }_{j = 1}^{n ( t )} {Z}_{j} ( t ) + {σ}_{B} B ( t )$$

wherein an initial value X(0)=0, and parameter setting values are as shown in Table 3:

TABLE 3

| D | l | α | β | γ | η | μ | σᵣ | σ_{B} |
|---|---|---|---|---|---|---|---|---|
| 350 | 6 | 1.8 | 0.3 | 0.2 | 0 | 0.5 | 0.05 | 0.95 |

For the case that shock only affects degradation rate and does not affect product degradation signal, wherein product degradation signal can be completely recovered in an instantaneous form, it is assumed that there are 100 products undergoing a 900-hour degradation test, and degradation data are generated every 0.01 hours. A stress profile is shown in FIG. 5. In a simulation process, the degradation data of the first 50000 data points are used to estimate model parameters, and then reliability is predicted. Corresponding failure data are obtained through the degradation data of the 50001st to 90000th data points, and prediction accuracy is verified. The performance degradation process of the product can be expressed as:

$$X ( t ) = X ( 0 ) + {\int }_{0}^{ t} r ( w ( v ) ) dv + {\sum }_{j = 1}^{n ( t )} {Z}_{j} ( t ) + {σ}_{B} B ( t )$$

wherein an initial value X(0)=0, and parameter setting values are as shown in Table 4:

TABLE 4

| D | Dₑ | α | β | γ | η | μ | σᵣ | σ_{B} |
|---|---|---|---|---|---|---|---|---|
| 500 | 3 | 0 | 0 | 0 | 0.015 | 0.5 | 0.3 | 0.95 |

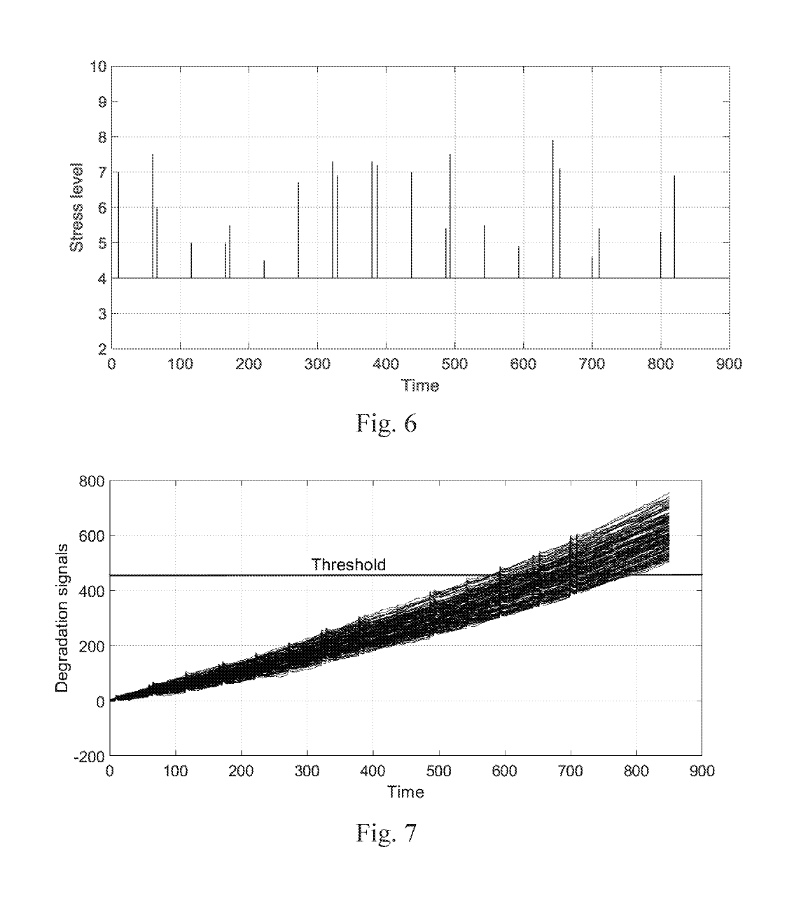

For the case that shock affects neither product degradation signal nor degradation rate, it is assumed that there are 100 products undergoing a 900-hour degradation test, and degradation data are generated every 0.01 hours. A stress profile is shown in FIG. 6. In a simulation process, the degradation data of the first 50000 data points are used to estimate model parameters, and then reliability is predicted. Corresponding failure data are obtained through the degradation data of the 50001st to 90000th data points, and prediction accuracy is verified. The performance degradation process of the product can be expressed as:

$$X ( t ) = X ( 0 ) + {\int }_{0}^{ t} r ( w ( v ) ) dv + {\sum }_{j = 1}^{n ( t )} {Z}_{j} ( t ) + {σ}_{B} B ( t )$$

wherein an initial value X(0)=0, and parameter setting values are as shown in Table 5:

TABLE 5

| D | α | β | γ | η | μ | σᵣ | σ_{B} |
|---|---|---|---|---|---|---|---|
| 350 | 0 | 0 | 0 | 0 | 0.5 | 0.3 | 0.95 |

According to the present invention, a method and steps therefore are described in detail as below:

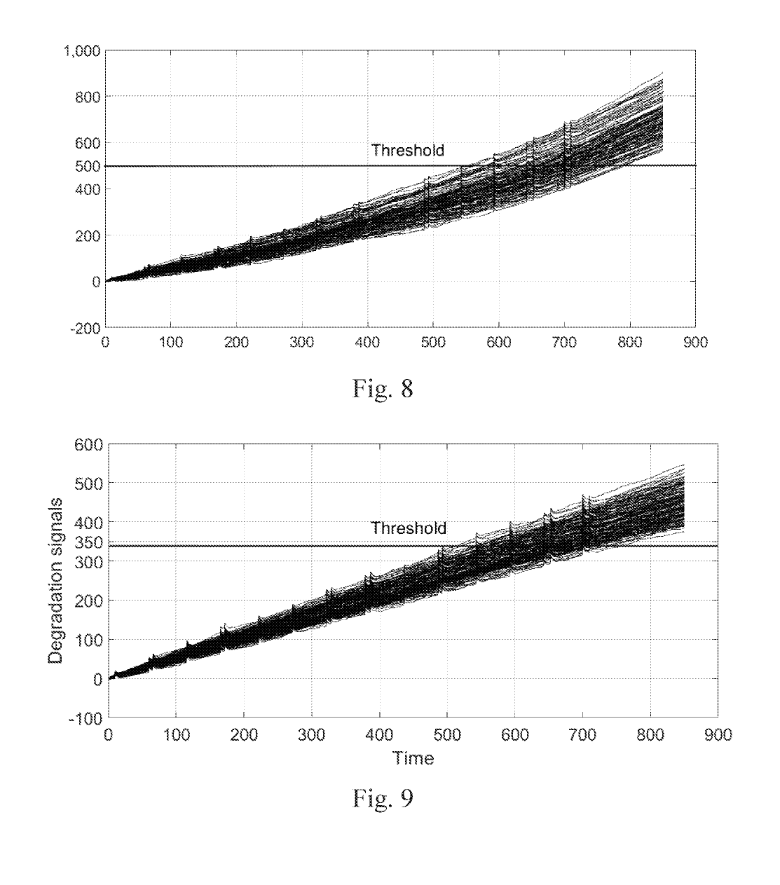

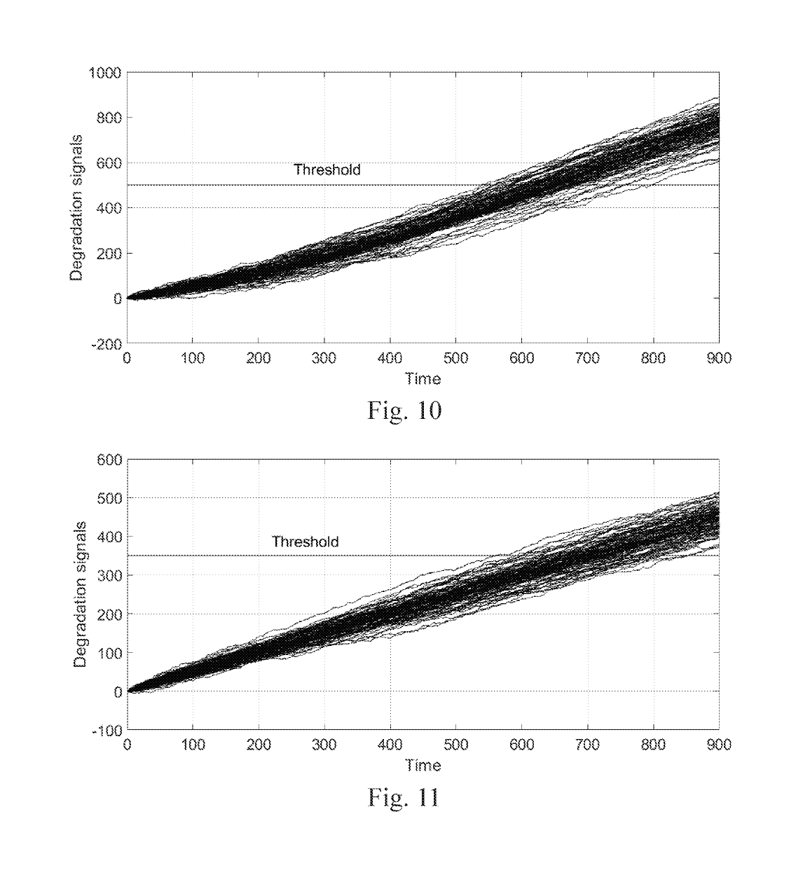

Step 1: collecting degradation data;

wherein the degradation data are generated by simulating experiments; a performance degradation process therefore is shown in FIGS. 7-11;

Step 2: establishing a degradation model;

wherein the performance degradation process is expressed by a model comprising initial value, a degradation rate cumulative function, a shock damage function, and a Wiener process;

Step 3: estimating the parameters;

wherein for the case that critical threshold l is greater than Dₑ, the degradation data of the first 44000 data points are used to estimate model parameters, so as to estimate critical threshold l and Dₑ with the method of the present invention, and then estimate the remaining unknown parameters according to a maximum likelihood method;

estimation results (parameter estimated values) are as shown in Table 6:

TABLE 6

| Dₑ | l | α | β | γ | η | μ | σᵣ | σ_{B} |
|---|---|---|---|---|---|---|---|---|
| 5.9 | 6.9 | 1.7 | 0.32 | 0.19 | 0.013 | 0.48 | 0.26 | 0.86 |

wherein for the case that critical threshold l is less than Dₑ, the degradation data of the first 43700 data points are used to estimate model parameters, so as to estimate critical threshold l and Dₑ with the method of the present invention, and then estimate the remaining unknown parameters according to a maximum likelihood method;

estimation results (parameter estimated values) are as shown in Table 7:

TABLE 7

| Dₑ | l | α | β | γ | η | μ | σᵣ | σ_{B} |
|---|---|---|---|---|---|---|---|---|
| 6.9 | 5.9 | 1.71 | 0.32 | 0.22 | 0.017 | 0.45 | 0.33 | 0.93 |

wherein for the case that shock only affects product degradation signal and does not affect degradation rate, wherein product degradation signal may be partially or fully recovered in a non-instantaneous form, the degradation data of the first 50000 data points are used to estimate model parameters, so as to estimate critical threshold l and Dₑ with the method of the present invention, and then estimate the remaining unknown parameters according to a maximum likelihood method;

estimation results (parameter estimated values) are as shown in Table 8:

TABLE 8

| l | α | β | γ | η | μ | σᵣ | σ_{B} |
|---|---|---|---|---|---|---|---|
| 5.9 | 1.82 | 0.27 | 0.23 | 0 | 0.46 | 0.06 | 0.93 |

wherein for the case that shock only affects degradation rate and does not affect product degradation signal, wherein product degradation signal can be fully recovered in an instantaneous form, the degradation data of the first 50000 data points are used to estimate model parameters, so as to estimate critical threshold l and Dₑ with the method of the present invention, and then estimate the remaining unknown parameters according to a maximum likelihood method;

estimation results (parameter estimated values) are as shown in Table 9:

TABLE 9

| Dₑ | α | β | γ | η | μ | σᵣ | σ_{B} |
|---|---|---|---|---|---|---|---|
| 2.9 | 0 | 0 | 0 | 0.013 | 0.46 | 0.27 | 0.91 |

wherein for the case that shock affects neither product degradation signal nor degradation rate, the degradation data of the first 50000 data points are used to estimate model parameters, so as to estimate critical threshold l and Dₑ with the method of the present invention, and then estimate the remaining unknown parameters according to a maximum likelihood method,

estimation results (parameter estimated values) are as shown in Table 10:

TABLE 10

| α | β | γ | η | μ | σᵣ | σ_{B} |
|---|---|---|---|---|---|---|
| 0 | 0 | 0 | 0.000002 | 0.47 | 0.32 | 0.98 |

Step 4: predicting lifetime and reliability;

wherein unknown parameters and the threshold D are substituted into a probability density function ƒ(t), and the reliability can be calculated from a reliability model R(t)=1−∫₀^{t}ƒ(ν)dν; furthermore, the reliability is compared with a Kaplan-Meier (K-M) reliability prediction method based on failure time, so as to verify prediction accuracy;

wherein for the case that critical threshold l is greater than Dₑ, the failure data is shown in Table 11 (failure time/hour):

TABLE 11

| | | | | | | | |
|---|---|---|---|---|---|---|---|
| 631 | 633 | 635 | 642 | 649 | 649 | 650 | 650 |
| 651 | 654 | 655 | 657 | 657 | 663 | 671 | 675 |
| 678 | 680 | 687 | 687 | 688 | 690 | 691 | 697 |
| 698 | 698 | 699 | 705 | 710 | 710 | 714. | 714 |
| 715 | 717 | 717 | 722 | 725 | 726 | 727 | 729 |
| 729 | 732 | 734 | 735 | 737 | 739 | 739 | 740 |
| 743 | 746 | 748 | 748 | 753 | 754 | 755 | 755 |
| 755 | 755 | 758 | 759 | 762 | 762. | 765 | 767 |
| 771 | 772 | 772 | 774 | 775 | 776 | 777 | 784 |
| 785 | 785 | 786 | 786 | 787 | 790 | 792 | 793 |
| 797 | 799 | 799 | 803 | 805 | 806 | 809 | 810 |
| 811 | 812 | 814 | 823 | 823 | 826 | 878 | 832 |
| 832 | 836 | 837 | 838 | — | — | — | — |

wherein for the case that critical threshold l is less than Dₑ, the failure data is shown in Table 12 (failure time/hour):

TABLE 12

| | | | | | | | |
|---|---|---|---|---|---|---|---|
| 558 | 558 | 562 | 567 | 567 | 568 | 575 | 575 |
| 576 | 576 | 586 | 595 | 595 | 597 | 608 | 609 |
| 612 | 615 | 615 | 616 | 618 | 621 | 622 | 625 |
| 626 | 635 | 638 | 639 | 639 | 643 | 643 | 646 |
| 649 | 654 | 656 | 659 | 660 | 661 | 665 | 665 |
| 671 | 673 | 675 | 676 | 678 | 678 | 681 | 681 |
| 682 | 684 | 685 | 689 | 689 | 691 | 691 | 692 |
| 692 | 702 | 704 | 705 | 707 | 708 | 709 | 710 |
| 711 | 712 | 713 | 714 | 716 | 717 | 721 | 722 |
| 724 | 725 | 730 | 730 | 731 | 735 | 737 | 738 |
| 739 | 743 | 744 | 744 | 745 | 746 | 748 | 750 |
| 750 | 750 | 757 | 760 | 767 | 767 | 775 | 777 |
| 778 | 779 | 786 | 788 | — | — | — | — |

wherein for the case that shock only affects product degradation signal and does not affect degradation rate, wherein product degradation signal may be partially or fully recovered in a non-instantaneous form, the failure data is shown in Table 13 (failure time/hour):

TABLE 13

| | | | | | | | |
|---|---|---|---|---|---|---|---|
| 535 | 536 | 539 | 540 | 546 | 548 | 549 | 554 |
| 555 | 555 | 557 | 557 | 557 | 559 | 559 | 568 |
| 579 | 579 | 582 | 583 | 584 | 593 | 595 | 595 |
| 596 | 597 | 599 | 600 | 607 | 611 | 613 | 617 |
| 619 | 621 | 623 | 628 | 630 | 631 | 632 | 636 |
| 640 | 641 | 643 | 645 | 646 | 648 | 649 | 653 |
| 653 | 653 | 655 | 656 | 657 | 659 | 663 | 663 |
| 665 | 666 | 668 | 671 | 675 | 676 | 677 | 678 |
| 678 | 679 | 680 | 685 | 685 | 689 | 691 | 692 |
| 694 | 694 | 702 | 702 | 704 | 706 | 707 | 708 |
| 708 | 713 | 717 | 722 | 72.5 | 726 | 730 | 734 |
| 736 | 739 | 741 | 751 | 752 | 757 | 765 | 771 |
| 772 | 773 | 776 | 781 | — | — | — | — |

wherein for the case that shock only affects degradation rate and does not affect product degradation signal degradation signal, wherein product degradation signal can be fully recovered in an instantaneous form, the failure data is shown in Table 14 (failure time/hour):

TABLE 14

| | | | | | | | |
|---|---|---|---|---|---|---|---|
| 540 | 547 | 548 | 549 | 560 | 563 | 565 | 566 |
| 567 | 572 | 579 | 580 | 582 | 583 | 585 | 586 |
| 588 | 591 | 592 | 593 | 593 | 594 | 595 | 596 |
| 600 | 601 | 601 | 601 | 609 | 610 | 612 | 614 |
| 618 | 618 | 621 | 625 | 628 | 632 | 635 | 638 |
| 640 | 641 | 642 | 646 | 649 | 649 | 651 | 653 |
| 653 | 654 | 655 | 656 | 656 | 658 | 661 | 664 |
| 667 | 668 | 674 | 674 | 676 | 678 | 680 | 681 |
| 683 | 684 | 685 | 689 | 692 | 698 | 698 | 702 |
| 705 | 705 | 706 | 707 | 709 | 713 | 721 | 725 |
| 726 | 727 | 728 | 736 | 739 | 743 | 745 | 746 |
| 747 | 750 | 750 | 750 | 752 | 754 | 755 | 758 |
| 763 | 767 | 767 | 772 | — | — | — | — |

wherein for the case that shock affects neither product degradation signal nor degradation rate, the failure data is shown in Table 15 (failure time/hour):

TABLE 15

| | | | | | | | |
|---|---|---|---|---|---|---|---|
| 562 | 571 | 572 | 572 | 575 | 578 | 584 | 590 |
| 590 | 596 | 599 | 599 | 602 | 603 | 605 | 607 |
| 609 | 611 | 616 | 619 | 626 | 632 | 634 | 635 |
| 635 | 636 | 641 | 642 | 642 | 644 | 653 | 659 |
| 660 | 663 | 663 | 672 | 672 | 675 | 683 | 688 |
| 690 | 697 | 698 | 702 | 703 | 706 | 708 | 715 |
| 720 | 720 | 720 | 726 | 726 | 731 | 731 | 739 |
| 744 | 748 | 751 | 751 | 751 | 757 | 758 | 762 |
| 763 | 765 | 766 | 776 | 778 | 779 | 779 | 780 |
| 780 | 782 | 786 | 790 | 791 | 792 | 797 | 797 |
| 799 | 801 | 804 | 807 | 819 | 823 | 825 | 826 |
| 826 | 830 | 831 | 831 | 836 | 838 | 838 | 838 |
| 838 | 838 | 840 | 849 | — | — | — | — |

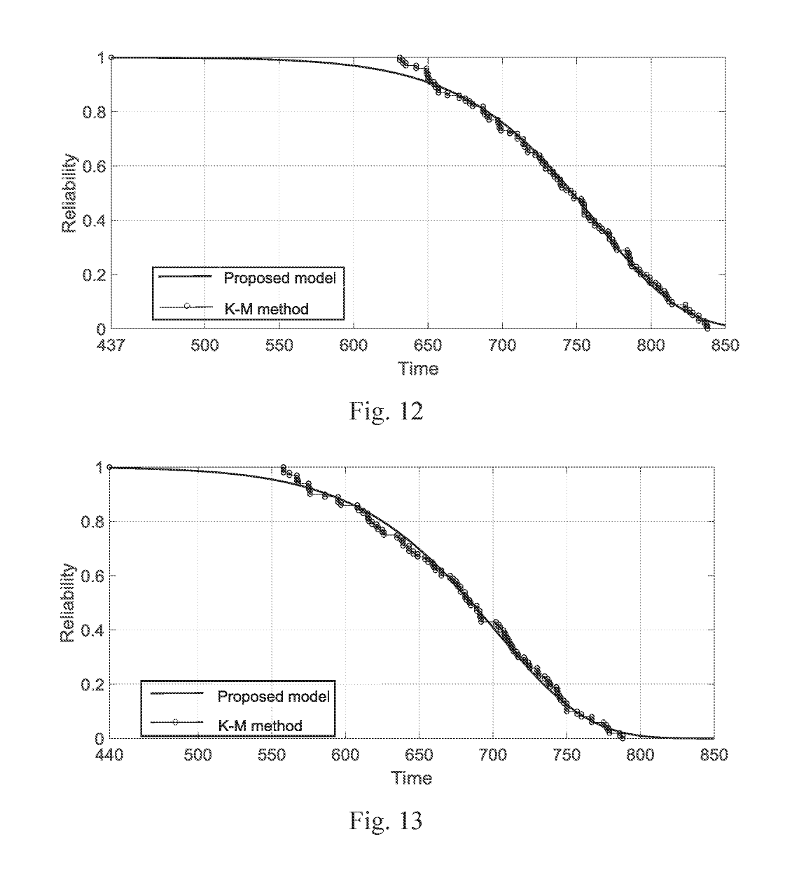

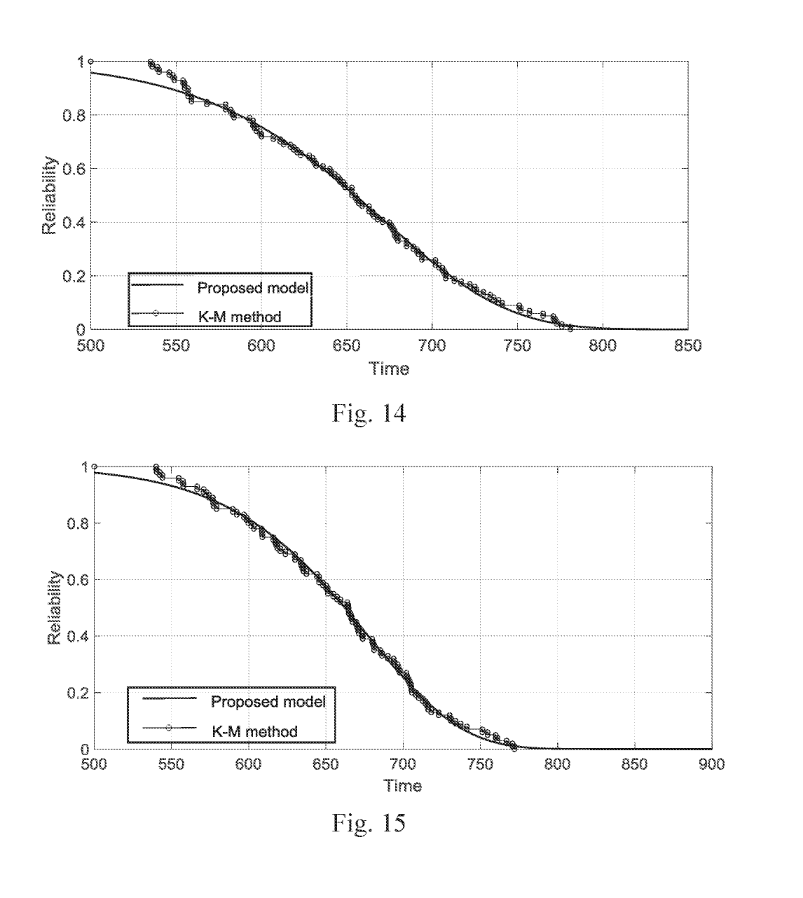

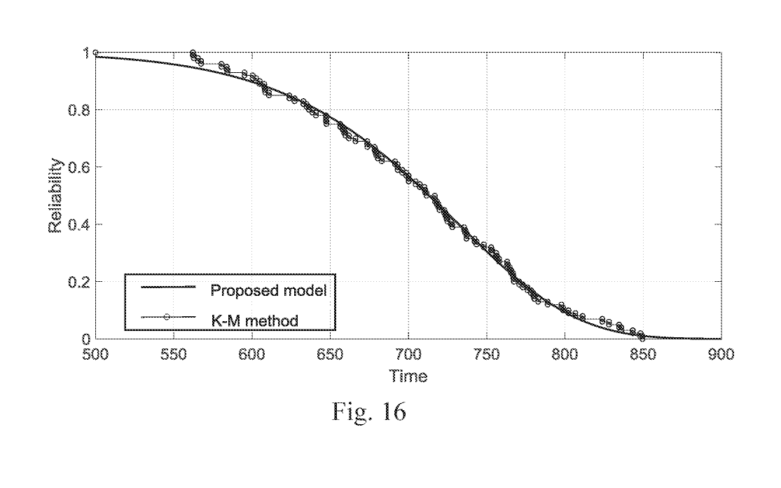

For the reliability curve predicted based on the degradation model and the curve predicted by the Kaplan-Meier method, Root Mean Squared Error (RMSE) of the five cases are respectively: 0.0152, 0.0191, 0.0193, 0.0203, 0.0191. The reliability curve and the curve predicted by the Kaplan-Meier method are close to each other as shown in FIGS. 12-16.

It can be seen from the above analysis that the present invention provides the method for lifetime prediction considering recoverable shock damages, which considers both the shock effect on the degradation rate and the degradation signals during the product degradation process. Therefore, the prediction method is more realistic and the prediction accuracy is improved.

What is claimed is:

1. A method for degradation modeling and lifetime prediction considering recoverable shock damages, comprising steps of:
Step 1: collecting degradation data;
wherein the degradation data are collected through experiments or field use, under each stress profile, the degradation data and a corresponding stress state quantity are sampled once at each preset sampling time point, so as to collect data in real time;
Step 2: establishing a degradation model;
wherein the degradation model is expressed by an initial value, a cumulative degradation rate effect, a stress shock damage effect, and a Wiener process as shown below,
$$X ( t ) = X ( 0 ) + {\int }_{0}^{ t} r ( w ( v ) ) dv + {\sum }_{j = 1}^{n ( t )} {Z}_{j} ( t ) + {σ}_{B} B ( t )$$
wherein X(0) is the initial of the product;
B(t) is a standard Wiener process, B(t)˜N(0,t);
w(t) is a value of an environment or a load at time t;
r(t) is a the degradation rate at time t;
σ_{B} is a diffusion parameter reflecting difference and instability during a product degradation process;
$${\sum }_{j = 1}^{n ( t )} {Z}_{j} ( t )$$
is a sum of shock damage caused by shocks up to time t, wherein j is the number of shock, N(t) is the number of the shocks occurred until time t, and Zⱼ(t) is an effect on a product degradation signal caused by the j^{th} shock until time t;
wherein l is further defined as a shock damage recovery critical threshold; when a shock magnitude is greater than l, a shock damage is not fully recoverable; otherwise, the shock damage is fully recoverable; the shock damage, which is an effect on the product degradation signal caused by the shocks, is expressed by an exponential function as follows,
if Δw(τⱼ)<l,
Zⱼ(t)=αΔw(τⱼ)·exp[−β(t−τⱼ)], t≥τⱼ
if Δw(τⱼ)≥l,
Zⱼ(t)=αΔw(τⱼ)·exp[−β(t−τⱼ)]+γΔw(τⱼ), t≥τⱼ
wherein α, β and γ are parameters to be estimated, τⱼ is an actual occurrence time of the j^{th} shock, and Δw(τⱼ) is the shock magnitude at the time τⱼ; γΔw(τⱼ) is a unrecoverable shock damage on the product degradation signal after a shock occurs;
as a special case, when α=0 and β=0,
if Δw(τⱼ)<l,
Zⱼ(t)=0, t≥τⱼ
if Δw(τⱼ)≥l,
Zⱼ(t)=γΔw(τⱼ), t≥τⱼ
for this case, Zⱼ(t) represents a product performance degradation process in which a shock damage is unrecoverable;
in addition, the degradation rate can be affected by the instantaneous shock, Dₑ is defined as a shock magnitude critical threshold which changes the degradation rate; when the shock magnitude is greater than Dₑ, the degradation rate increases, otherwise, the product degradation rate is unchanged, the shock effect on the product degradation rate is expressed by:
if Δw(τⱼ)<Dₑ,
Δrⱼ=0
if Δw(τⱼ)≥Dₑ,
Δrⱼ=η·Δw(τⱼ)
the degradation rate is an accumulation of a product initial degradation rate and degradation rate increments after each shock,
$$r ( t ) = {r}_{0} + {\sum }_{j = 1}^{n ( t )} Δ {r}_{j}$$
$$wherein , \\ {r}_{0} \text{∼} N ( μ , {σ}_{r}^{2} )$$
wherein, η is a parameter to be estimated, r₀ is the product initial degradation rate not affected by the shocks, r₀˜N(μ, σᵣ²); Δrⱼ is an increment of the degradation rate caused by the j^{th} shock;
Step 3: estimating the parameters;
wherein the degradation model assumes that a damage recovery process and the degradation rate increase process are independent of each other after the instantaneous shock; firstly, an estimation method of the critical thresholds l and Dₑ is proposed and estimated, and then other parameters are estimated according to a maximum likelihood method; and
Step 4: predicting lifetime and reliability;
wherein a lifetime and reliability prediction model considering recoverable shock damages is established and a reliability curve is drawn.

2. The method, as recited in claim 1, wherein estimation of the critical thresholds l and Dₑ in the Step 3 is divided into two cases according to whether the shock damage on the product degradation signal is recoverable, comprising: 1) the shock damage on the product degradation signal is recoverable, which means the shock damage has a recoverable trend after the shocks; and 2) the shock damage on the product degradation signal is unrecoverable, which means the shock damage has no recoverable trend after the shocks.

3. The method, as recited in claim 2, wherein when the shock damage on the product degradation signal is recoverable, and the shock damage has a recoverable trend after the shocks:
for the degradation data collected in the Step 1, n is defined as the number of the shocks occurred until time t, and a degradation rate between the j^{th} and j−1^{th} shocks is calculated and denoted as r_{1 (j-1,j)}; for each shock j, j=1, 2, . . . , n, a degradation rate between the first degradation data before the j^{th} shock and the first degradation data when a degradation signal stars to increase after the shock is calculated and denoted as r_{2 (j)};
if there is at least once r_{2 (j)}>r_{1 (j,j+1)}, and there is at least once r_{1 (j,j+1)}−r_{1 (j-1,j)}>0, j=1, 2, . . . , n−1; then,
$$l = \frac{{l}_{upper limit} + {l}_{lower limit}}{2}$$
$${l}_{upper limit} = min \{ Δ w ( {τ}_{j} ) \text{:} {r}_{2 ( j )} > {r}_{1 ( j , j + 1 )} , j = 1 , 2 , … , n - 1 \}$$
$${l}_{lower limit} = max \{ Δ w ( {τ}_{j} ) \text{:} {r}_{2 ( j )} = {r}_{1 ( j , j + 1 )} , j = 1 , 2 , … , n - 1 \}$$
when l_{lower limit} has no feasible solution, then l_{lower limit}=l_{upper limit};
$${D}_{e} = \frac{{D}_{{e}_{upper limit}} + {D}_{{e}_{lower limit}}}{2}$$
$${D}_{e upper limit } = min \{ Δ w ( {τ}_{j} ) \text{:} {r}_{1 ( j , j + 1 )} - {r}_{1 ( j - 1 , j )} > 0 , j = 1 , 2 , … , n - 1 \}$$
$${D}_{e lower limit } = max \{ Δ w ( {τ}_{j} ) \text{:} {r}_{1 ( j , j + 1 )} - {r}_{1 ( j - 1 , j )} = 0 , j = 1 , 2 , … , n - 1 \}$$
when D_{e lower limit} has no feasible solution, then D_{e lower limit}=D_{e upper limit};
if there is at least once r_{2 (j)}>r_{1 (j,j+1)}, and there is no r_{1 (j,j+1)}−r_{1 (j-1,j)}>0, j=1, 2, . . . , n−1; then,
$$l = \frac{{l}_{upper limit} + {l}_{lower limit}}{2}$$
$${l}_{upper limit} = min \{ Δ w ( {τ}_{j} ) \text{:} {r}_{2 ( j )} > {r}_{1 ( j , j + 1 )} , j = 1 , 2 , … , n - 1 \}$$
$${l}_{lower limit} = max \{ Δ w ( {τ}_{j} ) \text{:} {r}_{2 ( j )} = {r}_{1 ( j , j + 1 )} , j = 1 , 2 , … , n - 1 \}$$
when l_{lower limit} has no feasible solution, then l_{lower limit}=l_{upper limit};
meanwhile, Dₑ→+∞;
if there is no r_{2 (j)}>r_{1 (j,j+1)}, and there is at least once r_{1 (j,j+1)}−r_{1 (j-1,j)}>0, j=1, 2, . . . , n−1; then,
$${D}_{e} = \frac{{D}_{{e}_{upper limit}} + {D}_{{e}_{lower limit}}}{2}$$
$${D}_{e upper limit } = min \{ Δ w ( {τ}_{j} ) \text{:} {r}_{1 ( j , j + 1 )} - {r}_{1 ( j - 1 , j )} > 0 , j = 1 , 2 , … , n - 1 \}$$
$${D}_{e lower limit } = max \{ Δ w ( {τ}_{j} ) \text{:} {r}_{1 ( j , j + 1 )} - {r}_{1 ( j - 1 , j )} = 0 , j = 1 , 2 , … , n - 1 \}$$
when D_{e lower limit} has no feasible solution, then D_{e lower limit}=D_{e upper limit};
meanwhile, l→+∞;
if there is no r_{2 (j)}>r_{1 (j,j+1)}, and there is no r_{1 (j,j+1)}−r_{1 (j-1,j)}>0, j=1, 2, . . . , n−1; then l→+∞, Dₑ→+∞.

4. The method, as recited in claim 2, wherein when the shock damage on the product degradation signal is unrecoverable, and the degradation signal has no recoverable trend after the shocks:
for the degradation data collected, n is defined as the number of the shocks occurred until time t, and a degradation rate between the j^{th} and j−1^{th} shocks is calculated and denoted as r_{1 (j-1,j)}; for each shock j, j=1, 2, . . . , n, an increment X(τⱼ)−X(τⱼ−1) of a degradation signal between the j^{th} shock and the j−1^{th} shock is calculated and denoted as ΔX₍ⱼ₎;
if there is at least once ΔX₍ⱼ₎>0, j=1, 2, . . . , n, and there is at least once r_{1 (j,j+1)}−r_{1 (j-1,j)}>0, j=1, 2, . . . , n−1; then,
$$l = \frac{{l}_{upper limit} + {l}_{lower limit}}{2}$$
$${l}_{upper limit} = min \{ Δ w ( {τ}_{j} ) \text{:} {Δ X}_{( j )} > 0 , j = 1 , 2 , … , n \}$$
$${l}_{lower limit} = max \{ Δ w ( {τ}_{j} ) \text{:} {Δ X}_{( j )} = 0 , j = 1 , 2 , … , n \}$$
when l_{lower limit} has no feasible solution, then l_{lower limit}=l_{upper limit};
$${D}_{e} = \frac{{D}_{{e}_{upper limit}} + {D}_{{e}_{lower limit}}}{2}$$
$${D}_{e upper limit } = min \{ Δ w ( {τ}_{j} ) \text{:} {r}_{1 ( j , j + 1 )} - {r}_{1 ( j - 1 , j )} > 0 , j = 1 , 2 , … , n - 1 \}$$
$${D}_{e lower limit } = max \{ Δ w ( {τ}_{j} ) \text{:} {r}_{1 ( j , j + 1 )} - {r}_{1 ( j - 1 , j )} = 0 , j = 1 , 2 , … , n - 1 \}$$
when D_{e lower limit} has no feasible solution, then D_{e lower limit}=D_{e upper limit};
if there is at least once ΔX₍ⱼ₎>0, j=1, 2, . . . , n, and there is no r_{1 (j,j+1)}−r_{1 (j-1,j)}>0, j=1, 2, . . . , n−1; then,
$$l = \frac{{l}_{upper limit} + {l}_{lower limit}}{2}$$
$${l}_{upper limit} = min \{ Δ w ( {τ}_{j} ) \text{:} {Δ X}_{( j )} > 0 , j = 1 , 2 , … , n \}$$
$${l}_{lower limit} = max \{ Δ w ( {τ}_{j} ) \text{:} {Δ X}_{( j )} = 0 , j = 1 , 2 , … , n \}$$
when l_{lower limit} has no feasible solution, then l_{lower limit}=l_{lower limit};
meanwhile, Dₑ→+∞;
if there is no ΔX₍ⱼ₎>0, j=1, 2, . . . , n, and there is at least once r_{1 (j,j+1)}−r_{1 (j-1,j)}>0, j=1, 2, . . . , n−1; then,
$${D}_{e} = \frac{{D}_{{e}_{upper limit}} + {D}_{{e}_{lower limit}}}{2}$$
$${D}_{e upper limit } = min \{ Δ w ( {τ}_{j} ) \text{:} {r}_{1 ( j , j + 1 )} - {r}_{1 ( j - 1 , j )} > 0 , j = 1 , 2 , … , n - 1 \}$$
$${D}_{e lower limit } = max \{ Δ w ( {τ}_{j} ) \text{:} {r}_{1 ( j , j + 1 )} - {r}_{1 ( j - 1 , j )} = 0 , j = 1 , 2 , … , n - 1 \}$$
when D_{e lower limit} has no feasible solution, then D_{e lower limit}=D_{e upper limit};
meanwhile, l→+∞;
if there is no ΔX₍ⱼ₎>0, j=1, 2, . . . , n, and there is no r_{1 (j,j+1)}−r_{1 (j-1,j)}>0, j=1, 2, . . . , n−1; then l→+∞, Dₑ→+∞.

5. The method, as recited in claim 2, wherein in the Step 3, other parameters α, β, γ, η, σ_{B} and σᵣ except the critical thresholds l and Dₑ are estimated according to the maximum likelihood method; specifically, according to the maximum likelihood principle and the Wiener process with independent increments, a maximum likelihood formula is obtained:
$$L ( α , β , γ , η , μ , {σ}_{B} , {σ}_{r} ) = {\prod }_{j = 0}^{n} {\prod }_{i = 1}^{{m}_{j}} \frac{1}{\sqrt{2 π ( {σ}_{B}^{ 2} {t}_{i} + {σ}_{r}^{ 2} {t}_{i}^{ 2} )}} \cdot exp [ \frac{{( Δ X ( {t}_{i} ) - ( μ + {\sum }_{p = 1}^{j} ( {I}_{j} \cdot ηΔ w ( {τ}_{j} ) ) ) Δ {t}_{i} - {\sum }_{q = 1}^{j} ( {Z}_{j} ( {t}_{i} ) - {Z}_{j} ( {t}_{i - 1} ) ) )}^{2}}{2 ( {σ}_{B}^{ 2} {t}_{i} + {σ}_{r}^{ 2} {t}_{i}^{ 2} )} ]$$
$$wherein$$
$${I}_{j} = \{ \begin{matrix}0 , & when Δ w ( {τ}_{j} ) < {D}_{e} \\ 1 , & when Δ w ( {τ}_{j} ) \geq {D}_{e}\end{matrix}$$
mⱼ is a cumulative number of the degradation data collected between the j−1^{th} shock and the j^{th} shock; wherein “between the j−1^{th} shock and the j^{th} shock” indicates that the degradation data collected at “the j−1^{th} shock” is not included, and the degradation data at “the j^{th} shock” is included; Δtᵢ is the time interval between an i−1^{th} degradation data and an i^{th} degradation data.

6. The method, as recited in claim 2, wherein the Step 4 specifically comprises steps of:
supposing D is a soft failure threshold, and T is a time when a degradation signal first exceeds the threshold D and causes soft failure,
T=inf{t≥0;X(t)≥D}
wherein a reliability function at the time t is expressed as:
R(t)=P{T>t}=P{max X(u)<D,0≤u≤t}
the degradation signal X(t) is divided into a deterministic part ζ(t) and a random part ψ(t), which are:
$$X ( t ) = ζ ( t ) + ψ ( t )$$
$$ζ ( t ) = X ( 0 ) + {\int }_{0}^{ t} ( μ + {\sum }_{j = 1}^{n ( t )} Δ {r}_{j} ) dv + {\sum }_{j = 1}^{n ( t )} {Z}_{j} ( t )$$
$$ψ ( t ) = X ( t ) - ζ ( t ) , ψ ( t ) \text{∼} N ( 0 , {σ}_{B}^{ 2} t + {σ}_{r}^{ 2} {t}^{ 2} )$$
as a result, the reliability function is then expressed as:
$$R ( t ) = P \{ max X ( u ) < D , 0 \leq u \leq t \} = P \{ ψ ( u ) < D - ζ ( u ) , 0 \leq u \leq t \} = P \{ ψ ( u ) < g ( u ) , 0 \leq u \leq t \}$$
$$g ( t ) = D - ζ ( t ) = D - X ( 0 ) - {\int }_{0}^{ t} ( μ + {\sum }_{j = 1}^{n ( t )} Δ {r}_{j} ) dv - {\sum }_{j = 1}^{n ( t )} {Z}_{j} ( t )$$
wherein g(t) is a curve boundary corresponding to a standard Wiener process;
for the curve boundary g(t), calculating an approximate solution of the curve boundary by a boundary tangent method, and linearizing g(t),
$$\tilde{g} ( t ) = {a}_{t} + {b}_{t} t$$
$${b}_{t} = \frac{d}{dt} g ( t ) = - ( μ + {\sum }_{j = 1}^{n ( t )} Δ {r}_{j} ) - {\sum }_{j = 1}^{n ( t )} {Z}_{j}^{′} ( t )$$
$${a}_{t} = g ( t ) - {b}_{t} t = g ( t ) + ( μ + {\sum }_{j = 1}^{n ( t )} Δ {r}_{j} ) t + ( {\sum }_{j = 1}^{n ( t )} {Z}_{j}^{′} ( t ) ) t$$
$${Z}_{j}^{′} ( t ) = - β \cdot αΔ w ( {τ}_{j} ) \cdot exp [ - β ( t - {τ}_{j} ) ] , t \geq {τ}_{j}$$
wherein αₜ and bₜ represent an intercept and a slope of \tilde{g}(t) at the time t;
expressing the reliability function after linearizing g(t) as:
$$R ( t ) = P \{ max X ( u ) < D , 0 \leq u \leq t \} = P \{ ψ ( u ) < g ( u ) , 0 \leq u \leq t \} \approx P \{ ψ ( u ) < \tilde{g} ( u ) , 0 \leq u \leq t \}$$
according to the boundary tangent method, obtaining an expression of a probability density distribution function ƒ(t) when first exceeding:
$$f ( t ) \approx \frac{1}{\sqrt{2 π t}} ( \frac{\begin{matrix}D - X ( 0 ) - {\int }_{0}^{ t} ( μ + {\sum }_{j = 1}^{n ( t )} Δ {r}_{j} ) dv - {\sum }_{j = 1}^{n ( t )} {Z}_{j} ( t ) + \\ ( μ + {\sum }_{j = 1}^{n ( t )} Δ {r}_{j} ) t + ( {\sum }_{j = 1}^{n ( t )} {Z}_{j}^{′} ( t ) ) t\end{matrix}}{t \sqrt{{σ}_{B}^{2} + {σ}_{r}^{2} t}} ) \cdot exp ( - \frac{{( D - X ( 0 ) - {\int }_{0}^{ t} ( μ + {\sum }_{j = 1}^{n ( t )} Δ {r}_{j} ) dv - {\sum }_{j = 1}^{n ( t )} {Z}_{j} ( t ) )}^{2}}{2 t ( {σ}_{B}^{2} + {σ}_{r}^{2} t )} )$$
then, expressing the reliability function as:
R(t)=1−∫₀^{t}ƒ(ν)dν;
finally, drawing a curve based on the reliability model to predict the lifetime of the product.
